(19) United States
(12) Patent Application Publication
(10) Pub. No.: US 2010/0021138 A1
(43) Pub. Date: Jan. 28, 2010

(54) METHOD FOR THE DISTRIBUTED RECORDING OF A MULTIMEDIA STREAM, CORRESPONDING DEVICE AND COMPUTER PROGRAM PRODUCT

(75) Inventors: Olivier Perrault, Noyal Sur Vilaine (FR); Jean-Michel Magret, Thorigne-Fouillard (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/527,735

(22) PCT Filed: Feb. 22, 2008
(86) PCT No.: PCT/FR08/50303

§ 371 Date: Oct. 1, 2009

(30) Foreign Application Priority Data
Feb. 26, 2007 (FR) 0701370

(51) Int. Cl. H04N 5/91

(52) U.S. Cl. 386/95; 386/E05.001

(57) ABSTRACT

A method is provided for distributed recording of a set of data. The method includes a step of issuing a recording request by a requiring equipment, a step of distributing said recording on at least one equipment different from the requiring equipment and connected thereto by a communication network.

### CROSS-REFERENCE TO RELATED APPLICATIONS

This Application is a Section 371 National Stage Application of International Application No. PCT/FR2008/050303, filed Feb. 22, 2008 and published as WO 2008/113948 on Sep. 25, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure pertains to the field of recordings of sets of data, for example data conveyed by personal multimedia streams.

### BACKGROUND OF THE DISCLOSURE

At present, the recording of multimedia streams such as video streams or audio streams is mostly done locally. This means that a user wishing to record one or more of these streams must possess an apparatus enabling him to make a recording. Such an apparatus may be a video tape recorder, a DVD (digital versatile disc) type disc recorder or more recently a hard disk drive recorder.

The recent appearance of a type of television program broadcasting that uses xDSL (digital subscriber line) type networks, wired networks or again WiFi (wireless fidelity identifying a standard that entails the building of wireless local area networks) type wireless networks or networks according to the DVB (digital video broadcasting) standard permits new program recording modes, especially recording of programs within the network.

The recording of programs within the network, especially video or audio programs, has recently appeared because of a massive increase in the broadcasting of such programs using high bit rate networks. These programs are broadcast to subscribers through operators. In order to enable the reception of the programs, the operators provide subscribers with digital terminals also called STBs or set-top boxes. These terminals are used by the subscribers to receive digital streams corresponding to the programs by means of a communications network, decompress these streams and render them to an apparatus designed for this purpose, for example a television set, a computer screen or a sound rendering apparatus.

These operators have also proposed new modes of recording these digital streams by enabling them to be recorded within their network. Thus, a subscriber user wishing to record a broadcast does not necessarily need to have a personal recording device at his or her disposal. Through the network, this user may command the recording of a stream and the operator takes charge of the task of allocating the resources needed for this recording within its network. The operators also carry out the recording of streams systematically or almost systematically. Thus, a subscriber who wishes to view a program that he or she has not thought of recording may nevertheless be able to view it by means of the operator's network, and may be able to do so for a duration whose length may vary depending on the operator. The operator thus proposes a “video on demand” type of service.

Such recording modes are generally grouped together under the name NPVR (network personal video recording).

The general principle lies in the sending of one or more recording commands to a central recording server which identifies the streams to be recorded and saves these streams within dedicated storage spaces in the network.

Thus, the techniques known as NPVR type recording techniques rely on a specific approach to services proposed to subscribers while at the same time ensuring that the operators' investment is in principle lower because it does not require the installation of specific digital terminals at the subscribers' homes and at the same time pools storage costs. Thus, theoretically, when several customers program the same transmission, this transmission is recorded only once by the operator.

However, one drawback of this prior-art technique is that it leads to a relatively complex management of the streams to be recorded by the operators. Thus, to ensure that subscribers will have a persistence of broadcasts that they had not “thought” of recording, the operators record all the channels permanently, and then carry out eliminations so as to preserve only broadcasts which are subsequently viewed or recorded.

Another drawback of these prior-art techniques is related to the use of bandwidth that is substantial and cannot be pooled. Indeed, the operators re-broadcast the streams recorded on demand. The broadcasting of the recorded streams is therefore done in unicast (point-to-point mode) i.e. directly to the subscriber.

Furthermore, the subscribers demand perfect rendering quality and this prompts the operators to duplicate their servers as closely as possible to the customers, to greatly increase their storage capacities and therefore to increase the cost of the infrastructures, all the more so as the prices of video-on-demand servers are very great.

### SUMMARY

An exemplary embodiment of the present invention provides a solution that does not have the drawbacks of the prior art by an original method for recording a set of data.

According to an embodiment of the invention, such a method comprises:
a step for the formulating of a recording request by a requiring apparatus;
a step for the distribution of said recording to at least one apparatus distinct from said requiring apparatus and connected to this requiring apparatus by a communications network.

Thus, the recording method of an embodiment of the invention enables an apparatus to formulate requests for recording without this apparatus being necessarily the apparatus that effectively saves the recording. The physical recording of the set of data is distributed among apparatuses distinct from the apparatus from which the recording request has been formulated. The method of an embodiment of the invention can therefore be used to take account of the apparatuses of the network in order to make the recording unlike the prior-art techniques which take account only of the possibilities offered by the local apparatus.

According to an original embodiment of the invention, said method comprises:
a step for obtaining a piece of information representing a storage volume available for a storage of said recording and proper to said requiring apparatus, delivering a piece of information on available volume;
a step for identifying, as a function of said piece of available information on volume, at least one storage apparatus connected to the network and designed to carry out at least one part of the storage of said recording.

Thus, the recording method according to an embodiment of the invention makes it possible to take account of the volumes needed for the storage of the recordings (i.e. the physical possibilities offered for the storage by the apparatuses) to determine one or more storage locations for the recordings. The term “recording of a set of data” is understood to mean the product of the saving of this set of data with a view to its subsequent use. Such a recording must be the object of a storage, i.e. a physical preservation, so that it can be viewed subsequently. An embodiment of the invention therefore makes it possible, unlike in the prior-art solutions, to take account of the available storage volumes proper to the apparatuses of the network (communications terminals, routers, servers) to determine a storage location.

Thus, the method of an embodiment of the invention offers the possibility of transferring all or part of the storage of the recordings, for example for an apparatus that does not have sufficient space, to other apparatuses of the network. A distribution of this kind of storage space is used to pool costs. In other words, an embodiment of the invention enables an apparatus requiring a recording to have available storage spaces of other apparatuses of the network in order to save the requested recording.

According to one particular characteristic of the invention, said recording request comprises at least one parameter belonging to the group comprising at least:
a piece of information representing an identifier of said requiring apparatus;
a piece of information representing an instant of a start of recording;
a piece of information representing an instant of an end of recording;
a piece of information representing an identifier of at least one digital stream corresponding to said set of data.

Thus, the apparatus of the network which wishes to make the recording provides pieces of information enabling the creation of a link between the apparatus as such, for example in the form of an identifier, and pieces of information pertaining to the set of data, in a particular form which for example may be that of an audio-visual program. The recording request then makes it possible, by providing these parameters, to manage recordings make sure that the distributed storage space is efficiently used.

According to an original embodiment of the invention, said step for identifying at least one storage apparatus is implemented within a centralized server of recordings.

Thus, an embodiment of the invention is used to centralize the determining of the storage apparatuses. In one such embodiment, this centralization resolves difficulties related to the pooling of the storage spaces of the apparatuses. Indeed, according to the prior-art techniques of recording on a network, the recordings are made on video-on-demand servers. Such servers have available storage spaces characteristic of this use, i.e. spaces of very large capacity. The prior-art techniques therefore do not necessitate centralized identification of a storage server. In this embodiment of the invention however, the storage space is distributed among a plurality of storage apparatuses for which the size of storage space is not necessarily available. It is therefore possible in this embodiment to centralize the operations of determining the storage apparatuses to make them simpler.

According to one particular characteristic of the invention, said identification step comprises:
a step for computing a resultant volume, by difference between a volume needed for the storage of said recording and the volume represented by said piece of information on volume available within the requiring apparatus;
a step for searching, within said plurality of apparatuses, for at least one apparatus capable of storing at least one part of said recording as a function of said resultant volume.

Thus, an embodiment of the invention makes it possible to delinearize the storage of the recordings made within the network by the selection of at least one storage apparatus, depending on its own available storage volumes. The available storage volumes proper to the apparatuses of the network may be either transmitted by these apparatuses to a requiring apparatus or may be determined by the interrogation of a database which has these pieces of information available. The storage apparatuses selected therefore receive the order to carry out the storage of all or part of the recording. For example, a first apparatus may store a first time period of the recording for example with a duration of an hour while a second apparatus may store a second time period of the recording, for example with a duration of half an hour. The storage space is thus greatly rationalized. It is also possible to combine this aspect of distribution of the recording with the taking into account of the recording requests from users. For example, in the case of two users who have requested the recording of a same program but at different times, it is possible to envisage giving preference to the recording of the part requested by the user in the storage space of his or her apparatus while preserving the totality of the program for other users.

According to an original embodiment, said method comprises:
a step for transmitting the request for recording to a server for managing recording requests;
a step for the processing of said recording request by said server for managing, according to at least one determined processing parameter;
a step for transmitting at least one piece of information representing said recording request to said recording server.

Thus, an embodiment of the invention is used for the centralizing, within a server for managing recordings, of the data sent out by the different apparatuses that form the communications network. This centralizing is used for the uniform processing of the requests for recording as a function of processing parameters which improve the efficiency of the determining of the storage apparatuses.

According to one characteristic of an embodiment of the invention, at least one determined processing parameter is a piece of information representing a redundancy of said recording within said plurality of apparatuses of said communications network.

Thus, it is possible to manage the recordings according to a redundancy parameter, also called a feedback control parameter, used to define a threshold below which the recording will be effectively stored. Indeed, to mitigate any malfunctioning in the storage apparatuses of the communications network, it may be necessary to make several operations of storage of one recording. These multiple storage operations are then controlled by this redundancy parameter. In one particular embodiment of the invention, it is possible that the value of this redundancy parameter will be equal to one. In this case, only one copy of the recording will be kept within the plurality of storage apparatuses.

According to one particular characteristic of the invention, at least one determined processing parameter is a piece of information representing a maximum duration of preservation of said recording within said plurality of apparatuses of said communications network.

The method of an embodiment of the invention can also be used to manage the durations of preservation of the recordings. Indeed, in as much as an apparatus requests a recording without its being kept, at least in its totality, within its own storage space, it is necessary to determine a date beyond which this recording will no longer be saved. Such a constraint may prove to be necessary to ensure appropriate use of the storage spaces of the different apparatuses.

An embodiment of the invention also relates to a set of data representing an audiovisual program.

According to an embodiment of the invention, such a set of data is distributed over at least two distinct apparatuses interconnected within a communications network, each having available a storage resource and each carrying a portion of said recording.

Thus, a set of data of this kind optimizes the use of storage resources while at the same time ensuring the perenniality of the set.

In another embodiment, the invention also concerns a computer program product downloadable from a communications network and/or stored on a computer-readable medium and/or executable by a microprocessor.

According to the invention, in another embodiment, such a computer program product comprises program code instructions for the execution of the recording method as described here above.

### BRIEF DESCRIPTION OF THE DRAWINGS

Other features and advantages of shall appear more clearly from the following description of a preferred embodiment, given by way of a simple, illustrative and non-exhaustive example, and from the appended drawings, of which:

FIG. 1 is a block diagram of the general architecture of a system for implementing the recording method of an embodiment of the invention;

FIG. 2 describes a simplified architecture of a request managing server according to an embodiment of the invention;

FIG. 3 describes a simplified architecture of recording server according to an embodiment of the invention.

### DETAILED DESCRIPTION OF ILLUSTRATIVE EMBODIMENTS

An embodiment of the invention therefore proposes the recording of audiovisual programs in a shared and delinearized way. Such a recording may be defined for example in combination with a local digital recording and a recording on a communications network made available to the user, for example by an operator or by an Internet service provider.

Thus, a recording combination of this kind prevents the monopolizing of the VOD (video-on-demand) network resource unnecessarily and the distribution of the real storage of the recordings both on the total fleet of set-top boxes and in that of the VOD servers. An embodiment of the invention also proposes a sharing of the recordings to retrieve a recording made by a different person (for example a person situated within a proximity unit).

An embodiment of the invention also proposes a centralized driving of the recording of the STBs (set top boxes) to record audio visual programs for which nobody has spontaneously requested the recording.

The general principle of an embodiment of the invention therefore relies on the sharing of resources between different actors of the network in order to enable a pooling of the storage capacities of the recordings of the users.

Thus, it is possible to obtain as many economies of scale for the network infrastructure suppliers as it is to multiply the possibilities of recording provided by users who have STBs available. Indeed, as already emphasized, the users' recording capacities are very often limited and the operators, through network recording (NVPR) are not able to provide unlimited storage capacities to the users. An embodiment of the invention therefore proposes to pool the storage resources of the users in order to increase both the total storage space of each user and the possibilities that this user will view recordings that he has not programmed (for example because of an oversight).

A specific entity of the network (also called a recording server) may therefore for example drive the storage of unrequested recordings: it constantly records a certain number of channels both on the fleet of STBs of the users and on the storage resources proper to it (dedicated hard disk drives) for subsequent delinearized access. In this embodiment of the invention, the recording server can therefore set up complete feedback control over a space of the hard disk drives of the STBs. It is thus possible to use one or more STBs for a recording of a broadcast.

An embodiment of the invention also enables users to obtain a quality of rendering higher than that of the quality of rendering given by centralized video-on-demand servers. Indeed, in one particular embodiment of the invention, proximity sets are defined. These proximity sets consist of users who are connected to the operator's or provider's network and have subscribed to services for recording through geographically proximate networks.

Here below, the description presents especially several modes of implementing one or more embodiments of the invention. It is clear however that the invention is not limited to these particular embodiments. In particular, the architecture present is given only by way of an indication, the general inventive concept of an embodiment of the invention being, of course, that of the decentralizing of recording on the network.

In this embodiment, we present the implementation of the recording method of the invention in the context of a technical architecture that brings into play a request managing entity which contributes to the administration of the recording requests formulated by the users. This architecture also brings into play a recording server responsible for the general administration of the storage of the different recordings of the users.

Thus, the request managing server therefore carries out the management of the recording requests by means of a database containing references of the terminals and of the requested broadcasts and of the places of storage (terminal or network). The recording server for its part stores video contents in the network at the request of the request managing server.

In this embodiment, the recordings are therefore done in two stages. In a first stage, the users express their recording wishes to the request managing server which processes them. In a second stage, depending on the users' parameters, their digital terminals and the decisions taken by the request managing server, the recording server may command the effective storage of the recordings requested by the users.

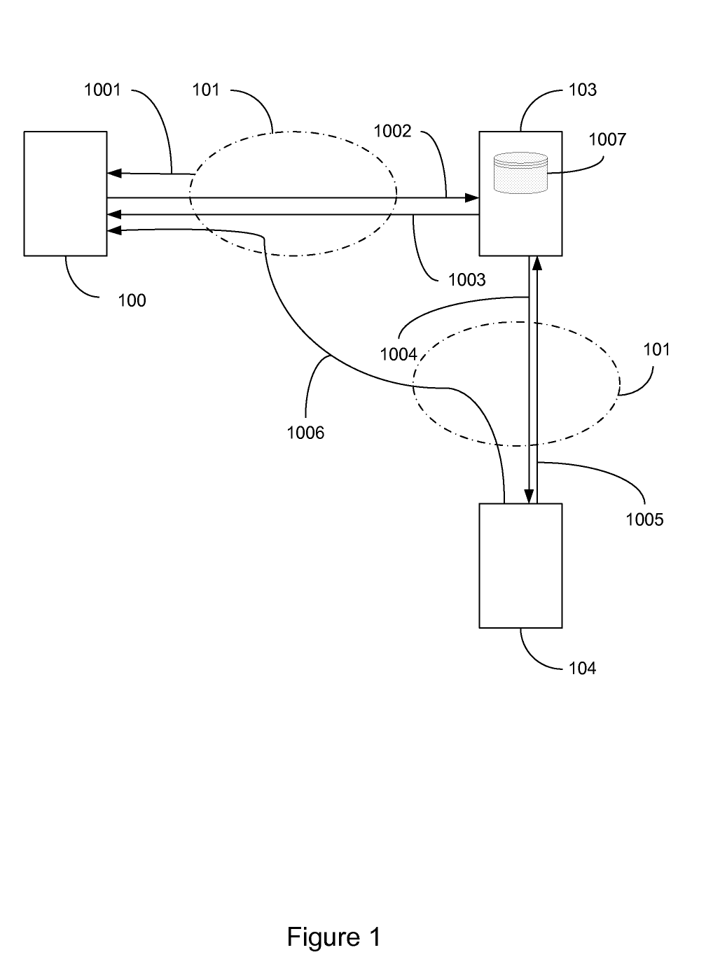

We now briefly present this embodiment by means of FIG. 1.

A terminal (for example a residential gateway or STB type terminal) 100 is connected to an operator's or access provider's network 101. This terminal receives (multicast or unicast) digital streams 1001 from the network. This terminal 100 is also connected to a request managing server 103 to which it transmits (1002) requests (requests for recording for example) and secondly from which it receives requests (1003).

The request managing server 103 is connected by means of the operator network to a recording server 104 to which it transmits (1004) requests for storing the recordings and from which it receives (1005) responses to these requests. In the case of a rendering of a recording to a user by means of the network, the recording server 104 provides 1006 the terminal 100 with a video stream (for example unicast if it is intended for only one user). In the case of retrieval of a recording at the user's premises, the recording server 104 receives the stream or the stream portion corresponding to its needs from the terminal 100.

In this particular embodiment, the request managing server 103 has a database 1007 enabling it to manage the recordings of the programs requested by the users. Within this database, the request managing server 103 associates, for each recording request, references of the recording (for example the channel number, the starting time, the ending time etc) to a unique identifier of the user's digital terminal.

It may be recalled indeed that the user's digital terminal in this particular embodiment has its own storage capacities, for example in the form of a hard disk drive. It is clear naturally that the embodiment is only an example of implementation. In this respect, it is necessary to envisage the use, within the request managing server, of all of the user's storage resources such as, for example, the storage resources available within his communications network by means of a personal computer or any other peripheral such as personal storage servers.

The request managing server 103 therefore has permanent knowledge of the user's recordings from this database 1007.

It is necessary in this embodiment to make a distinction between the relationships existing between the different actors and the way in which the linkages work.

The management of the recording requests formulated, in the form of commands, by the user to the terminal may be considered in this embodiment in two cases:
Case 1: the terminal 100 of the user has sufficient space available on the disk drive. In this case, the storage is done locally. At the end of the recording, the terminal 100 informs the server 103 that the recording is terminated. If the recording was not done properly (following an anomaly for example), the terminal 100 informs the server 103 through an anomaly message.
Case 2: the user's disk drive is full or the user does not have sufficient resources on his disk: the request managing server 103 memorises the recording request and the reference of the terminal and sends the request to the recording server 104.

In both cases, the recording request contains parameters of the programming of the user such as for example:
in the case of an immediate recording, the starting time and the duration of the recording;
in the case of a scheduled programmed recording, the dates and times of the starting and ending of recording;
in the case of a logic recording, an identifier of the audiovisual program derived for example from a program guide.

Naturally, in one complementary embodiment of the invention, it is possible during recording to pass from the first case to the second case. Thus, if a terminal 100 locally starts the recording of an audiovisual program, having free space on its hard disk drive, and if the totality of this space has just been consumed by the as yet unfinished recording, the terminal 100 may ask the request managing server 103 for a continuation of the recording on the network.

When the user's terminal has sufficient space on its hard disk drive and to prevent the use of unnecessary bandwidth during the reading, the recording is done on its hard disk. In doing so, in one embodiment providing for a feedback control of at least one part of the users' terminals to make the recording on the network, this local recording consequently releases the recording server 104 from having to make place for a recording, thus eliminating a feedback control over a terminal (for example an STB).

In other words, the management of the feedback controls over the users' terminals is done dynamically as a function of the users' own recording wishes. Thus it is not necessary to set up a feedback control of a terminal by dictating the recording of an audiovisual program on it if this program is already undergone several recordings elsewhere.

However, to overcome technical problems with the terminals if any, it is necessary to carry out redundant recordings. Thus, a redundancy threshold N is fixed, and is also called a feedback control parameter, used to ensure access to a given recording.

With regard to the reading of a recording, three possible cases need to be considered:
Case 1: the recording has been done on the user's terminal. The reading is therefore done directly from the terminal. This terminal informs the request managing server that it is unavailable. At the end of the reading, the terminal informs the request managing server that it is available. The launching of the reading of the recording proper is implemented by the request managing server which gives the read command to the terminal.
Case 2: the recording is requested from the recording server. The terminal therefore makes a content reading request to the request managing server. In this case, the request managing server in its response sends the terminal the information needed for reading the content, such as:
   The address of the streaming server, for example the “unicast” address for broadcasting the recording of the recording server;
   The parameters of the content (identifier, starting time, ending time etc).
Case 3: the user looks for a recording in the network. Indeed, it may be recalled that an embodiment of the invention enables the pooling of both storage resources and the recordings themselves. The user is therefore quite capable of searching for recordings that he has not himself thought of programming. The terminal then transmits its search parameters to the request managing server which does a search within its recording database 1007. The parameters of the search request may for example be:
dates and times for starting and ending the recording; and/or
an identifier of the broadcast being sought.

In the second and third cases, the recording server calls upon a driver of the unrequested recordings which will make queries with one or more terminals or its own storage resources to re-assemble the contents. These terminals send the stream or download the content which will be redirected to the user's terminal. Since this mechanism depends on the uplink bandwidth (from the terminals to the server), an intermediate server can splice itself into the system to reconstitute the full stream with a high level of quality.

With regard to the operations for eliminating recordings, an embodiment of the invention strives to pool the user's resources to the maximum extent in the embodiment of the invention described herein. Thus, a check is made before any elimination of the conditions of access subsequent to the recording that undergoes the elimination.

Two cases need to be distinguished:
Case 1: the content is on the disk drive of the user's terminal. To authorize elimination, the request managing server 103 asks the recording server 104 if this content is in the network or checks to see if it is still available in other terminals. Should the content not be available in the terminal and should it be available only on a number N of terminals, it must ask for a retrieval of content on one of the terminals concerned.
Case 2: the content is recorded within the network (on another terminal for example or within the recording server). The request managing server then limits itself to eliminating the user's to this recording within its database 1007.

In the case 1, N is a feedback control parameter. It is a value used to ensure the availability of the recordings within the network. In other words, this parameter serves to make sure that an audiovisual program which has been recorded by several users will always be available so long as all the users concerned have not asked for its elimination or so long as a period of time which is also parametrizable has not elapsed.

In the embodiment described here, the programming modifications are possible only for recordings that have not yet started. It is necessary to distinguish between the cases in which the terminal has sufficient space and cases in which it does not have sufficient space.
Case 1: sufficient and available place on the disk of the user's terminal. The terminal 100 makes a request for modification to the request managing server 103 which accepts it and takes account of modifications within its database 1007.
Case 2: the disk of the user's terminal is full. The request managing server 103 takes account of modifications within its database 1007 and asks the recording server to take account of the modifications.

In the embodiment of the invention described herein, the user has the possibility of searching for a content for which it is not preliminarily requested a recording. Such a search starts with a transmission of a search command from the terminal 100 to the data server 103 in order to make a search to find out if the content is available as a priority on the recording server and then on the terminals. If the content is available solely at the terminals, it must be retrieved on the recording server.

In the latter case, once the content has been retrieved, the request managing server 103 in its response sends the terminal 100 the information needed for reading the content such as:
address of the streaming server,
parameter of the contents (identifier, starting time, ending time etc)

In order to be able to retrieve a content that is available within a terminal, the request managing server 103 initially requests authorization for loading a content to the terminal 100. Such authorization can for example be refused if the terminal 100 is not available or again if the user does not wish to make this content public. In a second stage, when the downloading authorization is given to the request managing server, it transfers it to the recording server which downloads the content.

During a recording on the network (for example when the user's terminal no longer has sufficient space on its hard disk drive), the request managing server 103, after having taken account of the request for recording from the terminal in its database 1007, asks the recording server 104 for the recording of the audiovisual program. The recording server 104 checks the place available within its storage spaces. If the space is sufficient, the recording server 104 notifies acceptance of the request for recording to the request managing server 103 while at the same time giving it a storage identifier for this recording.

When a request for elimination coming from a user is transmitted to the request managing server 103, this server takes account of the request and if the recording has been stored in the network, it transmits this elimination request to the recording server 104 which, after having made the necessary checks, eliminates the recording and informs the request managing server 103 thereof.

When a recording has to be downloaded from a terminal of a first user to the recording server 104 (for example following a request for elimination or a search made by a second user) at reception of acceptance of downloading on the party of the first user with whom the recording is present, the recording server 104 performs the downloading and saves the recording in its storage space. At the end of the loading of the content, the recording server 104 informs the request managing server 103 that the content has been retrieved and gives it a unique identifier.

In one particular embodiment of the invention, it is possible jointly with the feedback control of the client's terminals to create a complementary distribution of the recordings at the terminals. Such a distribution may for example be implemented in order to optimize the use of the storage spaces by distributing a recording on several terminals.

Thus for example, the recording server may decide to distribute the recording of an audio visual program between several terminals. In this embodiment, for example, a terminal may be made responsible for recording (and storing) the first 20 minutes of a program while another terminal records the next 20 minutes and so on and so forth until the end of the audiovisual program. Thus, during the transfer of the audiovisual program, recorded according to this embodiment of the invention, to the recording server, the bandwidth used is reduced. Indeed, each terminal needs to transmit only a limited quantity of data corresponding to a reduced time. It is therefore brought into action for only very little time while the use of the user's Internet connection is not excessively restricted.

At least one embodiment of the invention envisages the segmenting of the recordings. Indeed, the audio visual programs are inter alia formed by several digital streams. These digital streams may undergo a segmentation. A recording would then consist of a set of segments, each segment corresponding to a stream, a starting time and an ending time. As such, a segment therefore represents a portion of a recording which can be stored independently of the other segments that form the recording.

Thus, the percentage of pooling of the recordings is further increased. Indeed, this embodiment takes account of the fact that an audiovisual program can be recorded with different parameters depending on the users.

In the present state of the art, for a same audio visual program P, a user U1 will “program” a recording starting at 20.00 hours and ending at 22.00 hours while another user U2 will “program” a recording that starts at 19.55 hours and ends at 22.05 hours. The request managing server is then faced with a problem:
either it takes a decision not to use the parameters of the user U2 (with the risk of displeasing him) and of asking for one and only one storage of the recording of the user U1 with the recording server. This storage will then be used both for the user U1 and for the user U2 and for other potential users;
or it will decide to use all the parameters of all the users at the risk of unnecessarily duplicating data. In this case, the user U1 and the user U2 are satisfied but the audiovisual program will be stored twice with overlapping timeslots.

In this embodiment, the segmentation of the recordings, for example into five-minute segments, enables the resources to be pooled. Thus, in our previous example, the user U2 could, depending on the space available in the hard disk drive of its terminal, locally have both segments corresponding to the 19.55-20.00 and 22.00-22.05 time slots while the rest of the segments will be stored in the network with or without a feedback control of the terminals of the users.

In other words, the recordings are fractioned between the users' terminals to meet their own programming wishes while at the same time preventing any unnecessary duplication of information. In the case of a feedback control of the terminals, a feedback control parameter N is used. This parameter therefore enables the feedback control of each segment. The result of this, for the request managing server, is greater complexity in the management of the users' requests. However, the satisfaction of these users is greater and the storage space is optimized.

A complementary embodiment of the invention introduces the notion of proximity set which, as already presented, enables the pooling of the storage spaces of terminals of users that are geographically close to one another. An implementation of the invention of this kind provides additional comfort of use for the users.

In this particular embodiment, a proximity set may be constituted for example by a digital subscriber line access multiplexer or distributor also called a DSL access multiplexer which may include a VOD server and all the clients of the operator or supplier connected to this DSLAM for their Internet access and/or video-on-demand access.

Thus, according to an embodiment of the invention, a population of users forming part of a set of proximity is constituted, the physical distances between these users being small. Consequently, the flow rates and the bandwidth available between these users are greater.

A proximity set may integrate all or part of the general architecture described here above (request managing server and recording server). In such a case, it is possible to implement a central entity for managing the recordings that supervises the recordings managed within each proximity set so as to, for example, duplicate the recordings of certain proximity sets in other proximity sets.

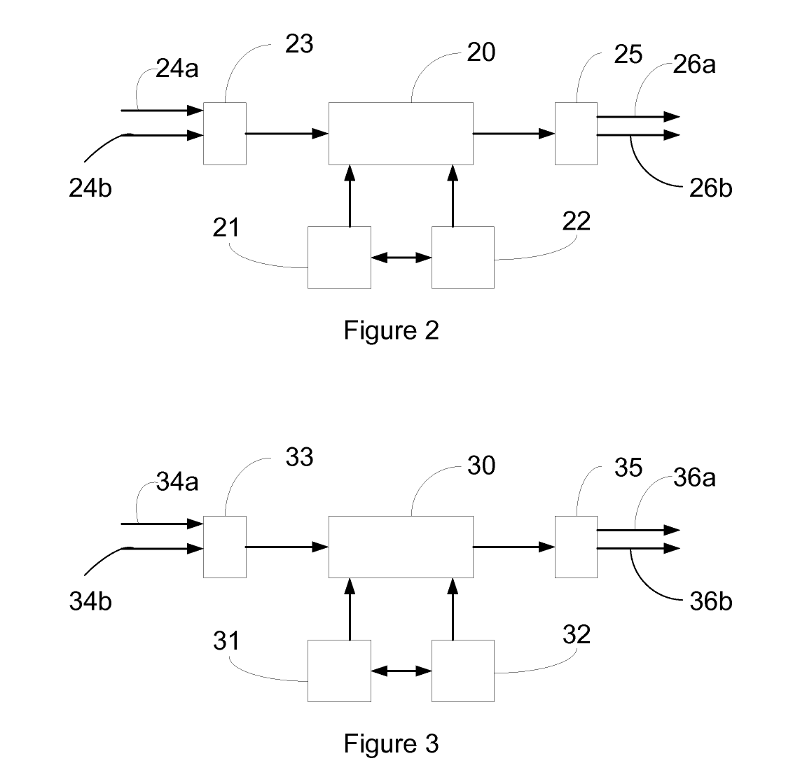

Referring now to FIG. 2, we present the simplified architecture of a request managing server according to an embodiment of the invention.

It comprises a memory 21 and a processing unit 20 equipped with a microprocessor driven by a computer program (or application) 22. The processing input 20 receives the following at input through a network input interface module 23:
requests coming from the terminals of the users 24a;
data on recordings coming from the recording servers 24b.

This information is processed by the microprocessor according to the instructions of the program 22 in order to:
confirm or negate the requests from the terminal 26a;
send (26b) commands to the recording server.

This data is transmitted through a network output interface module 25 to devices responsible for them.

Referring to FIG. 3, we present a simplified architecture of a request managing server according to an embodiment of the invention.

It has a memory 31, a processing unit 30 equipped with a microprocessor driven by a computer program (or application) 32. The processing unit 30 receives at input, through a network input interface module 33:
commands coming from the request managing server 34a;
data on recordings coming from the feedback controlled terminals 34b.

This information is processed by the microprocessor according to the instructions of the program 32 in order to:
confirm or negate the requests from the request managing server 36a;
send out (36b) commands to the feedback controlled terminals.

This data is transmitted through a network output interface module 35 to devices responsible for them.

Although the present disclosure has been described with reference to one or more examples, workers skilled in the art will recognize that changes may be made in form and detail without departing from the scope of the disclosure and/or the appended claims.

1-9. (canceled)

10. A method for recording a set of data, wherein the method comprises:
a step of formulating a recording request by a requiring apparatus; and
a step of distributing said recording to at least one apparatus distinct from said requiring apparatus and connected to this requiring apparatus by a communications network.

11. The method for recording according to claim 10 wherein the method comprises:
a step of obtaining a piece of information representing a storage volume available for a storage of said recording and proper to said requiring apparatus, delivering a piece of information on available volume; and
a step of identifying, as a function of said piece of available information on volume, at least one storage apparatus connected to the network and designed to carry out at least one part of the storage of said recording.

12. The method for recording according to claim 11, wherein said step of identifying at least one storage apparatus is implemented within a centralized server of recordings.

13. The method for recording according to claim 11, wherein said identification step comprises:
a step of computing a resultant volume, by a difference between a volume needed for the storage of said recording and the volume represented by said piece of information on volume available within the requiring apparatus; and
a step of searching, within said plurality of apparatuses, for at least one apparatus capable of storing at least one part of said recording as a function of said resultant volume.

14. The method for recording according to claim 10, wherein the method furthermore comprises:
a step of transmitting the request for recording to a server for managing recording requests;
a step of the processing of said recording request by said server for managing, according to at least one determined processing parameter; and
a step of transmitting at least one piece of information representing said recording request to said recording server.

15. The method for recording according to claim 14, wherein at least one determined processing parameter is a piece of information representing a redundancy of said recording within said plurality of apparatuses of said communications network.

16. The method for recording according to claim 15, wherein at least one determined processing parameter is a piece of information representing a maximum duration of preservation of said recording within said plurality of apparatuses of said communications network.

17. A method comprising:
providing a set of data representing an audiovisual program; and
distributing the set of data over at least two distinct apparatuses interconnected within a communications network, each having available a storage resource and each carrying a portion of a recording of the set of data, which is stored thereon.

18. A computer program product stored on a computer-readable medium and executable by a microprocessor, wherein the product comprises program code instructions for execution of a method of recording a set of data, when it is executed on a computer, wherein the method comprises:
formulating a recording request by a requiring apparatus; and
distributing said recording to at least one apparatus distinct from said requiring apparatus and connected to this requiring apparatus by a communications network.

19. A device for receiving at least one digital stream, the device comprising:
means for connecting to a communications network to receive at least one digital stream;
means for storing at least one part of said digital stream; and
means for formulating a recording request to activate recording of at least one part of said digital stream on at least one other available apparatus connected to said network.

20. The device according to claim 19, wherein the device comprises:
means for determining a piece of information representing a storage volume available with said storage means, activated upon reception of at least one part of a digital stream transmitted by a distinct apparatus through said communications network; and
means for transmitting said piece of information to said distinct apparatus.
